(19) United States
(12) Patent Application Publication
(10) Pub. No.: US 2003/0040220 A1
(43) Pub. Date: Feb. 27, 2003

(54) Input/output port having a tubular conductive terminal holder for use in a directional tap

(75) Inventor: Hansen Yang, Chung-Ho City (TW)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Cable Vision Electronics Co., Ltd.

(21) Appl. No.: 10/007,162

(22) Filed: Oct. 19, 2001

(30) Foreign Application Priority Data
Aug. 22, 2001 (TW) 090214392

(51) Int. Cl. H01R 9/05

(52) U.S. Cl. 439/579

(57) ABSTRACT

An input/output port for a directional tap includes an insulating seat, a conductive seat and a tubular terminal holder. The terminal holder is in electrical connection with the conductive seat and has a uniform-diameter portion and a converging portion, which extends from an end of the uniform-diameter portion, which is generally shaped as a truncated cone, and which has a small-diameter end that is distal to the uniform-diameter portion and that has a diameter smaller than that of the uniform-diameter portion. The converging portion is formed with a plurality of axial slits therethrough that define a plurality of jaws so as to be adapted to clamp a terminal of an input/output cable within the small-diameter end of the converging portion of the terminal holder, thereby establishing electrical connection between the terminal and the terminal holder.

### BACKGROUND OF THE INVENTION

1. Field of the Invention

The invention relates to an input/output port for a directional tap and a tubular conductive terminal disposed therein, more particularly to an input/output port with a tubular conductive terminal which has an improved holding effect.

2. Description of the Related Art

FIGS. 1 to 3 illustrate a conventional input/output port 5 which is installed in a directional tap 6, and which is connected electrically to both a terminal 71 of an input/output cable 7 that is connected to the directional tap 6 by means of an adapter 61, and a circuit board 62 within the direction trap 6 so that the input/output and distribution of signals can proceed through the directional tap 6. The input/output port 5 includes an insulating seat 51 disposed fixedly within a corner of a shell body 63 of the directional tap 6 by screwing, and a conductive seat 52 disposed within the insulating seat 51. The conductive seat 52 includes a terminal-receiving portion 521 fixed within the insulating seat 51, and a board-connecting portion 522 which projects outwardly from the terminal-receiving portion 521 so as to contact the circuit board 62. The terminal-receiving portion 521 is provided with a straight terminal-receiving hole 523 that is perpendicular to the board-connecting portion 522 for insertion of the terminal 71 into the terminal-receiving hole 523, and a threaded hole 524 that is perpendicular to the direction of the terminal-receiving hole 523 for engagement with an adjustment bolt 53. As shown in FIG. 3, due to the threaded engagement of the bolt 53 inside the threaded hole 524, the bolt 53 can press against the terminal 71, thereby ensuring electrical connection between the terminal 71 and the conductive seat 52.

Since the terminal 71 contacts the bolt 53, the terminal 71 is susceptible to bending, and the plating layer of the terminal 71 is susceptible to being destroyed, thereby resulting in oxidation at the terminal surface and an increase in the resistance. Furthermore, some of the video frequency signals transmitted by the directional tap 6 will be lost and the AC voltage will be reduced. Therefore, the quality of the video frequency signals will be affected adversely.

Referring to FIGS. 4 and 5, another conventional input/output port 8 for a directional tap is shown to include an insulating seat 81 composed of two opposite halves 811, 812, and a conductive seat 82 fixed within the insulating seat 81. A plastic hollow bearing portion 83 is disposed proximate to the conductive seat 82 within the insulating seat 81. A channel 823 is formed through the conductive seat 82 and the hollow bearing portion 83 so as to permit insertion of a tubular metal terminal holder 84 therethrough. A plurality of axial slits 841 are formed in a distal end of the tubular metal terminal holder 84 and are exposed from the conductive seat 82 so as to provide resiliency during insertion of the terminal 91 through the tubular metal terminal holder 84.

Although the terminal 91 is not susceptible to being destroyed, in view of the configuration of the input/output port 8 as described above, the resiliency of the tubular metal terminal holder 84 for clamping a terminal with a smaller diameter will be insufficient after repeated insertion of a terminal with a larger diameter into the tubular metal terminal holder 84. Therefore, the electrical connection between the terminal 9 and the conductive seat 82 will be unstable.

### SUMMARY OF THE INVENTION

Therefore, the object of the present invention is to provide an input/output port having a tubular conductive terminal holder for use in a directional tap which has an improved holding effect and which can ensure a stable electrical connection.

Accordingly, the input/output port for a directional tap of this invention is adapted to connect electrically a terminal of an input/output cable to a circuit board of the directional tap, and includes an insulating seat, a conductive seat and a tubular terminal holder. The insulating seat is adapted to be disposed fixedly in the tap. The conductive seat is disposed fixedly within the insulating seat and is adapted to be in electrical connection with the circuit board. The tubular terminal holder is made of a conductive material and is adapted to be sleeved on the terminal. The terminal holder is in electrical connection with the conductive seat and has a uniform-diameter portion and a converging portion, which extends from an end of the uniform-diameter portion, which is generally shaped as a truncated cone, and which has a small-diameter end that is distal to the uniform-diameter portion and that has a diameter smaller than that of the uniform-diameter portion. The converging portion is formed with a plurality of axial slits therethrough that define a plurality of jaws so as to be adapted to clamp the terminal within the small-diameter end of the converging portion of the terminal holder, thereby establishing electrical connection between the terminal and the terminal holder.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional input/output port disposed in a directional tap;

FIG. 2 is a sectional view of the directional tap of FIG. 1 taken along line II-II;

FIG. 3 is a schematic partly sectional view, illustrating how a terminal of a cable is pressed against a conductive seat by an adjustment bolt in the directional tap of FIG. 1;

FIG. 4 is an exploded sectional view of another conventional input/output port for a directional tap;

FIG. 5 is a schematic partly sectional view of the input/output port of FIG. 4 in a state of use;

FIG. 6 is an exploded sectional view of the preferred embodiment of the input/output port according to this invention;

FIG. 7 is a perspective view of the preferred embodiment of a tubular terminal holder of the input/output port according to this invention;

FIG. 8 is a sectional view of the input/output port of FIG. 6 in a state of connecting a terminal to a conductive seat;

FIG. 9 is a schematic view of the preferred embodiment of the input/output port according to this invention in a state of use in a directional tap; and

FIG. 10 is a sectional view of the directional tap of FIG. 9 taken along line X-X.

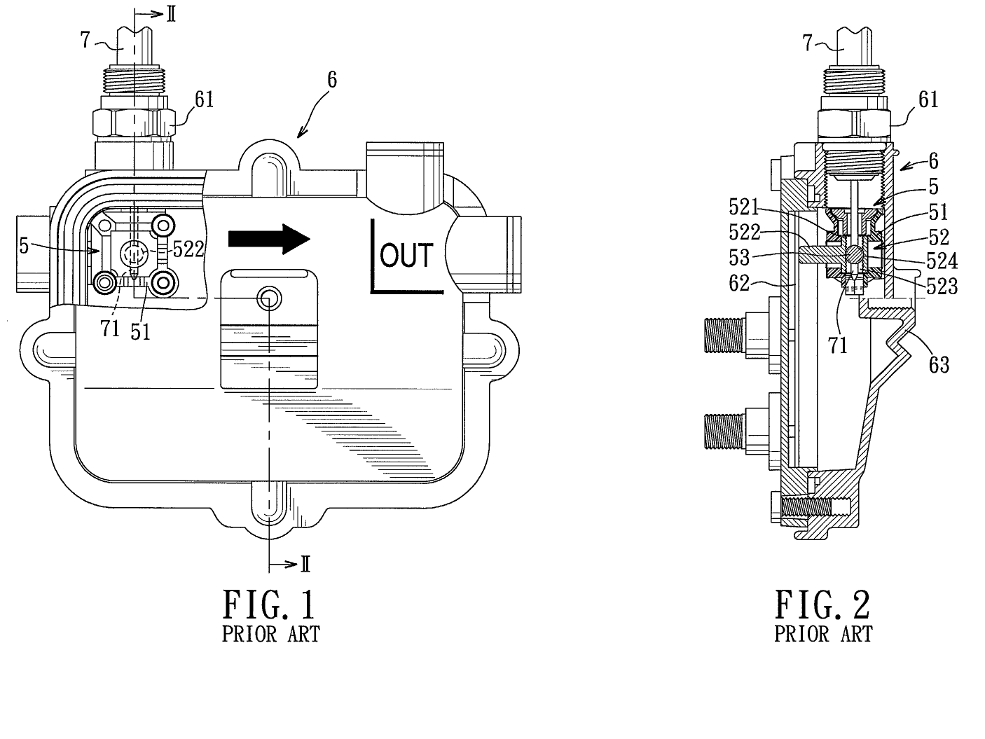

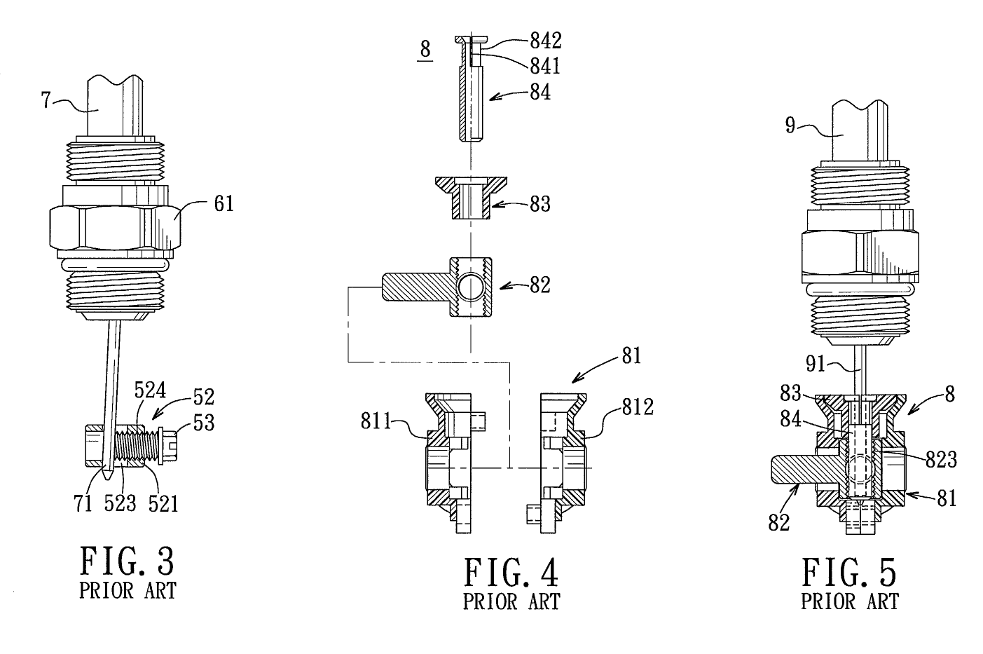

### DETAILED DESCRIPTION OF THE PREFERRED EMBODIMENT

Referring to FIGS. 8 to 10, the preferred embodiment of the input/output port 1 of this invention is adapted to be installed within a directional tap 2, which includes a circuit board 22 fixed therein. The input/output port 1 connects electrically a terminal 31 of an input/output cable 3, which is connected to the directional tap 2 by means of an adapter 21, to the circuit board 22 for the input/output and distribution of signals through the directional tap 2.

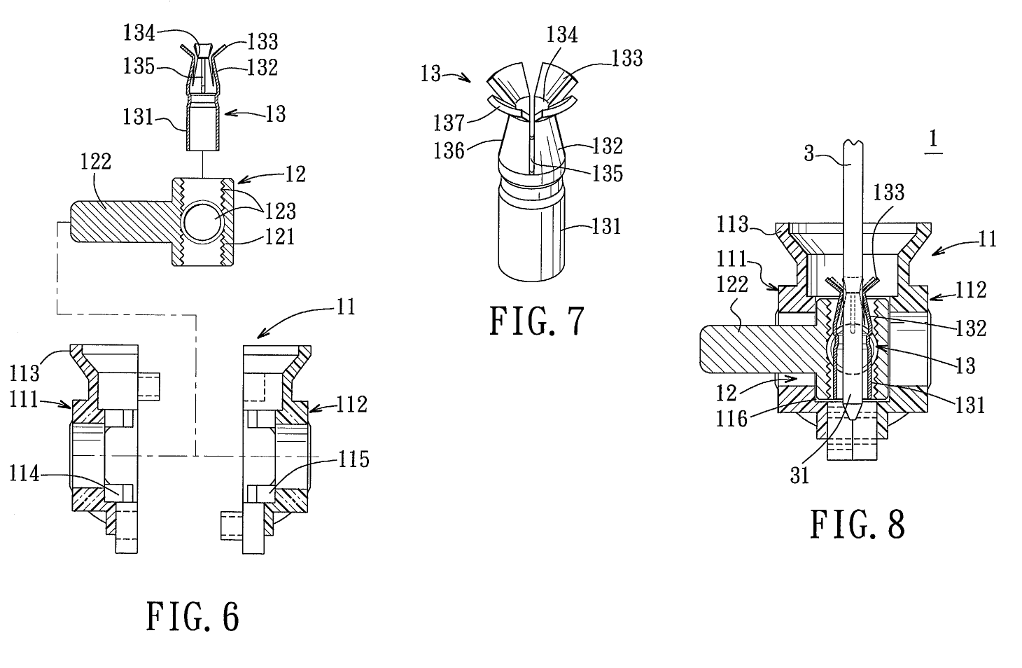

With further reference to FIGS. 6 to 8, the preferred embodiment of the input/output port 1 includes an insulating seat 11, a conductive seat 12 and a tubular terminal holder 13.

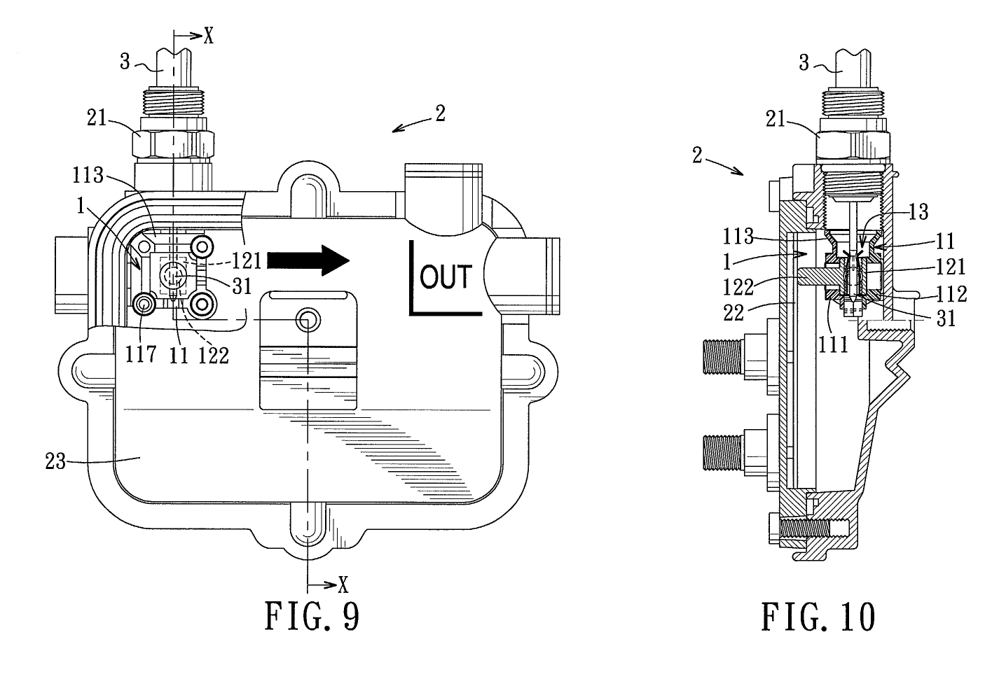

The insulating seat 11 is adapted to be disposed fixedly in the directional tap 2. The insulating seat 11 includes two halves 111, 112 that are made of an insulating material, such as plastic, and that are connected removably to each other. The two halves 111, 112 define a hollow housing which has a rectangular cavity 116 and a diverging hole 113. The cavity 116 is defined by rectangular blocking portions 114, 115 of the halves 111, 112. Referring to FIG. 9, the insulating seat 11 is disposed fixedly within a corner of a shell body 23 of the directional tap 2 by screws 117. The diverging hole 113 of the insulating seat 11 is directed toward the adapter 21.

The conductive seat 12 is disposed fixedly within the cavity 116 of the insulating seat 11 and is adapted to be in electrical connection with the circuit board 22. The conducting seat 12 includes a terminal-receiving portion 121 that is fixed within the cavity 116 of the insulating seat 11, and a board-connecting portion 122 that is formed integrally with the terminal-receiving portion 121 and that projects outwardly from the halves 111, 112 of the insulating seat 11 so as to be adapted to contact the circuit board 22. The conductive seat 12 further includes two straight terminal-receiving holes 123, which are perpendicular to each other and which have open ends so as to be adapted to permit insertion of the terminal 31 into a selected one of the terminal-receiving holes 123. The terminal-receiving holes 123 are formed in the terminal-receiving portion 121.

The tubular terminal holder 13 is made of a conductive material, is unitary, is adapted to be sleeved on the terminal 31, is in electrical connection with the conductive seat 12, and has a uniform-diameter portion 131 and a converging portion 132, which extends from an end of the uniform-diameter portion 131, which is generally shaped as a truncated cone, and which has a small-diameter end 134 that is distal to the uniform-diameter portion 131 and that has a diameter smaller than that of the uniform-diameter portion 131. Preferably, the terminal holder 13 is welded within the selected one of the terminal-receiving holes 123. The converging portion 132 is formed with a plurality of axial slits 135 therethrough that define a plurality of jaws 136 so as to be adapted to clamp the terminal 31 within the small-diameter end 134 of the converging portion 132 of the terminal holder 13, thereby establishing electrical connection between the terminal 31 and the terminal holder 13.

The terminal holder 13 further includes a diverging end portion 133, which extends from the small-diameter end 134 of the converging portion 132, which is generally shaped as a truncated cone, and which includes a plurality of jaw extensions 137 that are connected respectively and fixedly to the jaws 136 of the converging portion 132, thereby facilitating insertion of the terminal 31 into the terminal holder 13. Preferably, the converging portion 132 has an axial length that is longer than that of the diverging end portion 133. Furthermore, the jaws 136 form an angle with respect to an axis of the terminal holder 13, which is smaller than that formed by the jaw extensions 137.

In view of the aforesaid, as compared to the conventional input/output port for a directional tap, the input/output port 1 for a directional tap 2 according to this invention can achieve an improved effect for holding the terminal 31 within the input/output port 1. A stable electrical connection between the terminal 31 and the circuit board 22 within the directional tap 2 can thus be ensured. Therefore, the aforesaid drawbacks of the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An input/output port for a directional tap, the tap including a circuit board that is disposed fixedly therein, the port being adapted to connect electrically a terminal of an input/output cable to the circuit board, said port comprising:
an insulating seat adapted to be disposed fixedly in the tap;
a conductive seat disposed fixedly within said insulating seat and adapted to be in electrical connection with the circuit board; and
a tubular terminal holder made of a conductive material and adapted to be sleeved on the terminal, said terminal holder being in electrical connection with said conductive seat and having a uniform-diameter portion and a converging portion, which extends from an end of said uniform-diameter portion, which is generally shaped as a truncated cone, and which has a small-diameter end that is distal to said uniform-diameter portion and that has a diameter smaller than that of said uniform-diameter portion, said converging portion being formed with a plurality of axial slits therethrough that define a plurality of jaws so as to be adapted to clamp the terminal within said small-diameter end of said converging portion of said terminal holder, thereby establishing electrical connection between the terminal and said terminal holder.

2. The input/output port as claimed in claim 1, wherein said terminal holder further includes a diverging end portion, which extends from said small-diameter end of said converging portion, which is generally shaped as a truncated cone, and which includes a plurality of jaw extensions that are connected respectively and fixedly to said jaws of said converging portion, thereby facilitating insertion of the terminal into said terminal holder.

3. The input/output port as claimed in claim 2, wherein said converging portion has an axial length that is longer than that of said diverging end portion.

4. The input/output port as claimed in claim 2, wherein said jaws form an angle with respect to an axis of said terminal holder, which is smaller than formed by said jaw extensions.

5. The input/output port as claimed in claim 2, wherein said terminal holder is unitary.

6. The input/output port as claimed in claim 1, wherein said conductive seat includes two straight terminal-receiving holes, which are perpendicular to each other and which have open ends so as to be adapted to permit insertion of the terminal into a selected one of said terminal-receiving holes.

7. The input/output port as claimed in claim 6, wherein said terminal holder is welded within the selected one of said terminal-receiving holes.

8. The input/output port as claimed in claim 6, wherein said insulating seat includes two halves that are connected removably to each other, said conducting seat including a terminal-receiving portion that is fixed between said halves, and a board-connecting portion that is formed integrally with said terminal-receiving portion and that projects outwardly from said halves so as to be adapted to contact the circuit board, said terminal-receiving holes being formed in said terminal-receiving portion.

9. A tubular conductive terminal holder for a directional tap, the tap including a circuit board that is disposed fixedly therein, and an input/output port that connects electrically a terminal of an input/output cable to the circuit board, said terminal holder being adapted to be sleeved on the terminal and comprising a uniform-diameter portion and a converging portion, which extends from an end of said uniform-diameter portion, which is generally shaped as a truncated cone, and which has a small-diameter end that is distal to said uniform-diameter portion and that has a diameter smaller than that of said uniform-diameter portion, said converging portion being formed with a plurality of axial slits therethrough that define a plurality of jaws so as to be adapted to clamp the terminal within said small-diameter end of said converging portion, thereby establishing electrical connection between the terminal and said terminal holder.

10. The tubular conductive terminal holder as claimed in claim 9, further comprising a diverging end portion, which extends from said small-diameter end of said converging portion, which is generally shaped as a truncated cone, and which includes a plurality of jaw extensions that are connected respectively and fixedly to said jaws of said converging portion, thereby facilitating insertion of the terminal into said terminal holder.

11. The tubular conductive terminal holder as claimed in claim 10, wherein said converging portion has an axial length that is longer than that of said diverging end portion.

12. The tubular conductive terminal holder as claimed in claim 10, wherein said jaws form an angle with respect to an axis of said terminal holder, which is smaller than that formed by said jaw extensions.

13. The tubular conductive terminal holder as claimed in claim 10, wherein said converging portion is formed integrally with said uniform-diameter portion and said diverging end portion.
